(19) United States
(12) Patent Application Publication
(10) Pub. No.: US 2026/0367871 A1
(43) Pub. Date: Nov. 19, 2026

(54) METHOD AND SYSTEM OF INTEGRATING INSIGHTS INTO AN APPLICATION INTERFACE

(71) Applicant: Honeywell International Inc., Charlotte, NC (US)

(72) Inventors: Ankit Singh, Apex, NC (US); Kartik Bollapalli, Bangalore (IN); Waad Subber, Schenectady, NY (US)

(21) Appl. No.: 19/206,080

(22) Filed: May 13, 2025

(51) Int. Cl. G06F 8/10; G06F 3/0485; G06F 9/451

(52) U.S. Cl. CPC G06F 8/10; G06F 3/0485; G06F 9/451

(57) ABSTRACT

The disclosure relates to a method and system for integrating insights into the user interface of an application to enhance visibility into Software Development Life Cycle (SDLC) findings. The method includes receiving an access request from a user at an application management system and retrieving one or more assigned attributes of the user based on the access request. Based on the retrieved attributes, an insights mode is enabled, providing SDLC-related insights associated with the application. A flag feature of the application is validated, where the flag feature toggles between a standard user mode and the insights mode. Upon activation of the insights mode, relevant insights are aggregated from multiple data sources, including security scans, cost management systems, performance metrics, and historical findings repositories. The aggregated insights are then overlaid and displayed directly on the user interface.

### TECHNICAL FIELD

The present disclosure relates to software development lifecycle (SDLC) processes. More particularly, the present disclosure pertains to a system and method for dynamically overlaying role-specific alerts, notifications, and recommendations on a software application's user interface (UI).

### BACKGROUND

Modern software-as-a-service (SaaS) products typically undergo a sequence of development phases. Each phase—such as infrastructure design, application architecture, security adherence, cost optimization, and performance—is crucial to the overall quality of the product. Multiple teams or roles are responsible for ensuring their respective key performance indicators (KPIs) and best practices are satisfied at each stage of the SDLC.

While various automated tools and processes exist to detect issues (e.g., cost overruns, security vulnerabilities, performance bottlenecks), the corresponding alerts and tickets often reside in disparate systems. This scattering of information makes it difficult to visualize, at a glance, which issues pertain to which parts of the application. Consequently, stakeholders lack a centralized, context-rich view that ties each finding directly to the relevant UI component or service.

As a result, the current approaches to managing distributed findings and recommendations are time-consuming, prone to human error, and may lead to miscommunication among stakeholders. There is a need for a centralized, UI-based mechanism that consolidates these alerts, offers role-specific insights, and provides dynamic, context-aware suggestions for remediation-improving SDLC comprehension and facilitating executive-level sign-off.

### SUMMARY

The present disclosure addresses the above issues by providing an interactive overlay on the application UI that surfaces distributed SDLC findings in a unified, context-rich manner. This interactive overlay is enabled or disabled through feature flags, which allow authorized users such as, developers, security champions, architects, and executives to toggle between a “customer view” of the application and an “engineering insights view.”

According to an aspect of the disclosure, a method of integrating insights into an interface of an application is disclosed. The method comprises receiving, at an application management system, an access request from a user and retrieving one or more assigned attributes of the user based on the received access request. The method further comprises enabling an insights mode based on the one or more retrieved attributes of the user, where the insights mode comprises Software Development Life Cycle (SDLC) insights of the application. Further, the method comprises validating a flag feature of the application, where the flag feature is configured to toggle between a user mode and the insights mode, aggregating insights of the application from multiple data sources based on the enabled insights mode, and displaying the insights of the application on the interface.

In some embodiments, displaying the insights of the application on the interface comprises enabling zoom-in and zoom-out functionalities for adjusting a level of detail of the displayed insights of the application.

In some embodiments, aggregating the insights of the application from the multiple data sources comprises generating AI-based remediation suggestions, where generating the AI-based remediation suggestions comprising analysing historical data and prior remediation strategies associated with the insights of the application, and generating the AI-based remediation suggestions for the insights based on one or more predefined thresholds, the historical data, and the prior remediation strategies.

In some embodiments, the one or more assigned attributes comprise one or more of security, financial operations, architecture, and performance perspectives.

In some embodiments, the multiple data sources further comprise one or more of security scans, cloud cost management systems, Application Programming Interface (API) testing results, large language models (LLMs), and historical insights.

In some embodiments, the method further comprises integrating the application management system with one or more external systems including JIRA, Confluence, security scanners, and cloud budget explorers, to retrieve the insights.

In some embodiments, displaying the insights of the application on the interface further comprises providing attribute-specific overlays to tailor the displayed insights of the application based on the respective assigned attributes of different users.

In some embodiments, the flag feature is toggled in real time between the user mode and the insights mode without requiring a restart of the application.

In some embodiments, the method further comprises generating business impact information for the aggregated insights of the application by performing an LLM-based analysis of API signatures and corresponding security risks.

In some embodiments, the method further comprises dynamically updating the display of insights on the interface as the user navigates between different screens of the application.

In yet another embodiment, an application management system of integrating insights into an interface of an application is disclosed. The system comprises a receiving module, a retrieving module, an enabling module, a validation module, an aggregation module, and a display module. The receiving module is configured to receive an access request from a user. The retrieving module is configured to retrieve one or more assigned attributes of the user based on the received access request. The enabling module is configured to activate an insights mode based on the one or more retrieved attributes of the user, where the insights mode comprises Software Development Life Cycle (SDLC) insights of the application. The validation module is configured to validate a flag feature of the application, where the flag feature is configured to toggle between a user mode and the insights mode. The aggregation module is configured to retrieve and collect insights of the application from multiple data sources based on the enabled insights mode. The display module is configured to dynamically display the insights of the application on the interface.

In some embodiments, the display module is further configured to enable zoom-in and zoom-out functionalities for adjusting the level of detail of the displayed insights of the application.

In some embodiments, the aggregation module is further configured to generate AI-based remediation suggestions, where generating the AI-based remediation suggestions comprised of analysing historical data and prior remediation strategies associated with the insights of the application and generating the AI-based remediation suggestions for the insights based on one or more predefined thresholds, the historical data, and the prior remediation strategies.

In some embodiments, the one or more assigned attributes comprise one or more of security, financial operations, architecture, and performance perspectives.

In some embodiments, the multiple data sources further comprise one or more of security scans, cloud cost management systems, Application Programming Interface (API) testing results, large language models (LLMs), and historical insights.

In some embodiments, the system further comprises an integration module configured to integrate with one or more external systems including JIRA, Confluence, security scanners, and cloud budget explorers, to retrieve the insights.

In some embodiments, the display module is further configured to provide attribute-specific overlays to tailor the displayed insights of the application based on the respective assigned attributes of different users.

In some embodiments, the flag feature is toggled in real time between the user mode and the insights mode without requiring a restart of the application.

In some embodiments, the system further comprises a generation module configured to generate business impact information for the aggregated insights of the application by performing an LLM-based analysis of API signatures and corresponding security risks.

In yet another embodiment, a non-transitory computer-readable medium is disclosed, having stored thereon computer-executable instructions that, when executed by a processor, cause the processor to execute a method of integrating insights into an interface of an application. The method comprises receiving, at an application management system, an access request from a user and retrieving one or more assigned attributes of the user based on the received access request. The method further comprises enabling an insights mode based on the one or more retrieved attributes of the user, where the insights mode comprises Software Development Life Cycle (SDLC) insights of the application. Further, the method comprises validating a flag feature of the application, where the flag feature is configured to toggle between a user mode and the insights mode, aggregating insights of the application from multiple data sources based on the enabled insights mode, and displaying the insights of the application on the interface.

The disclosed method and system enable organizations to consolidate scattered insights into a unified, interactive application interface, reducing reliance on multiple external monitoring tools. By providing role-specific insights, real-time overlays, AI-based remediation, and seamless integration with external systems, the application management system optimizes operational efficiency, enhances security management, and improves cost and performance monitoring.

This summary is provided to describe select concepts in a simplified form that are further described in the detailed description. This summary is not intended to identify key or essential features of the claimed subject matter, nor is it intended to be used as an aid in determining the scope of the claimed subject matter.

### BRIEF DESCRIPTION OF DRAWINGS

Embodiments of the subject matter will hereinafter be described in conjunction with the following drawing figures, wherein like numerals denote like elements, and:

FIG. 1 illustrates an architectural overview consolidating multiple perspectives and data sources to create a unified, dynamic overlay of findings on an application's user interface according to an embodiment of this disclosure;

FIG. 2 illustrates an illustrative user interface for a “Recall Management” application according to an embodiment of this disclosure;

FIG. 3 illustrates a method for integrating insights into an application's interface, enabling real-time visibility into Software Development Life Cycle (SDLC) findings according to an embodiment of this disclosure;

FIG. 4 illustrates an application management system that enables the seamless integration of insights into an application interface according to an embodiment of this disclosure; and

FIG. 5 illustrates a schematic diagram of a communication apparatus according to an embodiment of this disclosure.

Further, skilled artisans will appreciate that elements in the drawings are illustrated for simplicity and may not have necessarily been drawn to scale. For example, the flow charts illustrate the method in terms of the most prominent steps involved to help improve understanding of aspects of the present disclosure. Furthermore, in terms of the construction of the apparatus, one or more components of the apparatus may have been represented in the drawings by conventional symbols, and the drawings may show only those specific details that are pertinent to understanding the embodiments of the present disclosure so as not to obscure the drawings with details that will be readily apparent to those of ordinary skill in the art having the benefit of the description herein.

### DETAILED DESCRIPTION

The following description should be read with reference to the drawings, in which like elements in different drawings are numbered in like fashion. The drawings, which are not necessarily to scale, depict examples that are not intended to limit the scope of the disclosure. Although examples are illustrated for the various elements, those skilled in the art will recognize that many of the examples provided have suitable alternatives that may be utilized.

As used in this specification and the appended claims, the singular forms “a”, “an”, and “the” include the plural referents unless the content clearly dictates otherwise. As used in this specification and the appended claims, the term “or” is generally employed in its sense including “and/or” unless the content clearly dictates otherwise.

It is noted that references in the specification to “an embodiment”, “some embodiments”, “other embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is contemplated that the feature, structure, or characteristic may be applied to other embodiments whether or not explicitly described unless clearly stated to the contrary.

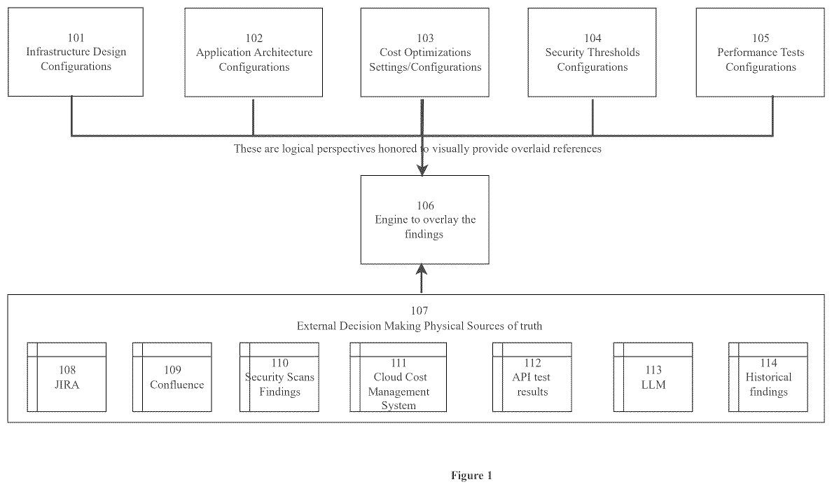

FIG. 1 illustrates an architectural overview consolidating multiple perspectives and data sources to create a unified, dynamic overlay of findings (hereinafter interchangeably referred to as “insights”) on an application's user interface according to an embodiment of this disclosure. At the top of the figure, several categories of “Configurations” are depicted—namely infrastructure design configurations 101, application architecture configurations 102, cost optimization settings/configurations 103, security thresholds configurations 104, and performance tests configurations 105. These categories represent logical perspectives for generating and displaying the most relevant alerts, recommendations, and contextual data for different user roles.

In one embodiment, the infrastructure design configurations 101 encompass a range of parameters that define the underlying system architecture, such as network topology, resource allocation policies, container orchestration strategies, and virtualization settings. In an embodiment, the system evaluates these parameters against predetermined best practices, real-time telemetry, and historical performance data to surface potential performance bottlenecks or security gaps. For instance, the system may analyze the network topology to identify suboptimal routing paths or single points of failure that could lead to degraded performance or service interruptions under high load. Similarly, by examining the resource allocation policies, the system can detect over-or under-provisioned compute instances, containers, or virtual machines, providing alerts that guide infrastructure teams to right-size these resources for cost efficiency and reliability.

Moreover, in this embodiment, the system correlates the configurations with data from container orchestration platforms such as Kubernetes or Docker Swarm—to detect misconfigurations that could expose vulnerabilities or limit scalability. For example, if a container is granted excessive privileges or lacks appropriate security profiles, the system flags the issue and displays a context-aware alert to security-focused stakeholders. The same mechanism applies to resource allocation strategies, where the method may highlight inconsistent CPU or memory limits that hinder performance.

This embodiment further integrates with external data sources, such as security scan findings and real-time monitoring logs, to enhance the accuracy of the identified issues. For instance, if a security scan reveals known vulnerabilities within a particular container image, the system cross-references the infrastructure design configurations 101 to determine whether the container is deployed in a critical production environment. If so, it raises a high-severity alert that appears as an overlay on the user interface for authorized roles (e.g., security champions, infrastructure architects), prompting immediate remediation.

By centralizing these configuration parameters and their evaluations, the system ensures that potential issues stemming from infrastructure design choices are proactively surfaced and made visible through the role-based overlay system. This holistic view reduces the likelihood of blind spots, allowing both technical and executive stakeholders to quickly assess infrastructure health, weigh remediation options, and maintain alignment with organizational objectives for performance, security, and cost-effectiveness.

The application architecture configurations 102 encompass a set of parameters and design principles that define the high-level structure and organization of a software application. This embodiment of the system is centered on evaluating how well the application's architecture adheres to established modular design patterns, such as microservices, layered architectures, or event-driven designs, as well as to industry-recognized best practices. By systematically analyzing these architectural elements, the system identifies potential deviations from optimal design principles such as tightly coupled components, redundant code, or a monolithic structure that could hinder scalability and surfaces these issues as alerts within the system's dynamic overlay.

For example, if a module within the application does not align with the prescribed separation of concerns or if an architectural decision has resulted in suboptimal code reuse, the system flags these areas for review. Furthermore, the system uses static analysis tools and historical code quality data to assess compliance with design standards, ensuring that any misalignments or degradation in code quality are promptly highlighted. This enables architects, developers, and other stakeholders to rapidly identify and address underlying structural issues, thereby maintaining the integrity and performance of the software application over its lifecycle.

The cost optimization settings/configurations 103 empower the system to continuously track and analyze the financial aspects of an application's operation. In this embodiment, the system integrates with cloud management platforms and financial monitoring tools to continuously gather data on runtime expenses, including compute, storage, and networking costs. It correlates this data with cloud resource usage patterns and budgeting alerts from various sources, such as cloud providers' cost management services and internal financial systems.

In an embodiment, the system applies predefined thresholds and rules set as part of the cost optimization configurations to identify anomalies, such as unexpected spending surges or persistent budget overruns. When such conditions are detected, the system generates role-based overlays on the application's user interface. These overlays visually alert stakeholders such as FinOps professionals, project managers, or system administrators to areas where costs are exceeding set limits or where there might be opportunities to reduce expenditure through optimization.

For example, if a particular microservice is consuming disproportionate resources relative to its budget, the system flags this issue, enabling the responsible teams to investigate and adjust resource allocation accordingly. Overall, the cost optimization settings/configurations 103 ensure that the financial health of the application is continuously monitored and managed, facilitating prompt corrective actions that align operational expenses with organizational budgeting goals.

The security threshold configurations 104 define a set of criteria that establish acceptable risk levels and compliance parameters, serving as the benchmark against which security-related data is evaluated. In an embodiment, these configurations include specific risk tolerance values such as maximum allowable vulnerability severity scores, acceptable exposure durations, and regulatory compliance standards and they dictate the operational limits within which the system must function.

The system further integrates with a variety of scanning tools, such as static and dynamic analysis platforms, container vulnerability scanners, and network security monitors, as well as with comprehensive vulnerability databases that provide up-to-date information on known security issues. As the system continuously collects security data from these sources, it compares the findings against the pre-established thresholds. When a particular issue exceeds the defined risk level, for example, if a vulnerability is detected with a severity rating above the acceptable limit-the system flags this concern immediately.

Moreover, the system prioritizes the flagged issues based on their severity and potential impact, ensuring that the most critical vulnerabilities are brought to the forefront of the role-based overlay. This targeted alerting mechanism enables security champions, compliance officers, and other relevant stakeholders to focus their attention on high-priority security concerns, thereby facilitating rapid response and remediation. By dynamically adjusting to real-time security data and leveraging the predefined thresholds, the system not only enhances situational awareness but also supports continuous compliance with industry standards and internal security policies throughout the application lifecycle.

The performance tests configurations 105 focus on the continuous monitoring and evaluation of key performance metrics such as throughput, latency, and concurrency limits. In an embodiment, the system is designed to gather detailed performance data in real time, enabling it to detect any anomalies or deviations from established benchmarks. For instance, a sudden drop in throughput, an unexpected increase in latency, or concurrency levels exceeding predetermined limits would be identified as potential performance issues. Once these anomalies are detected, the system generates targeted recommendations aimed at addressing the root causes whether that involves scaling resources, fine-tuning the codebase, or optimizing load distribution.

By integrating the performance tests configurations 105 with the other configuration categories, infrastructure design, application architecture, cost optimization, and security thresholds—the disclosure consolidates these five distinct perspectives into a single & unified framework. This integration ensures that every user, regardless of their role, receives a tailored overlay of insights directly on the application's user interface. Whether, the user is a security champion, architect, DevOps engineer, or financial stakeholder, the real-time, role-based insights facilitate immediate awareness and prompt action on any critical issues. This approach streamlines cross-functional collaboration, improves the overall situational awareness of system health, and enhances decision-making throughout the software development lifecycle by providing a holistic view of both technical and financial performance metrics.

The “Engine to overlay the findings” 106 acts as the central processing unit that drives the capability to provide a dynamic, real-time overlay of critical insights on an application's user interface. This engine 106 is designed to ingest, interpret, and synthesize data from a variety of external decision-making “physical sources of truth.” For instance, it gathers issue and ticket information from JIRA 108, integrates project documentation and historical context from Confluence 109, and incorporates vulnerability data from Security Scans Findings 110. It also collects cost-related metrics from the Cloud Cost Management System 111, performance and functional metrics from API test results 112, and leverages advanced analytical capabilities of Large Language Models (LLMs) 113 to offer contextual analysis and remediation suggestions. Further, Historical Findings repositories 114 provide the engine with past data and trends, enabling it to compare and contrast current findings with previous incidents.

By correlating these diverse data streams with the pre-configured settings across multiple perspectives, such as Infrastructure Design, Application Architecture, Cost Optimization, Security Thresholds, and Performance Tests—the engine produces role-based overlays. These overlays are tailored to highlight issues, pinpoint potential optimizations, and recommend actionable remediation steps that are specific to the user's role. For example, a security champion might see prioritized alerts on vulnerabilities, whereas a financial stakeholder might be presented with notifications about cost overruns or opportunities for savings. This integrated approach ensures that the overlays are not only comprehensive but also contextually relevant, providing stakeholders with an immediate, at-a-glance understanding of the application's health and performance directly on the user interface.

In one embodiment, an enterprise application might use the disclosed method to show a “Security Champion” only the security-related vulnerabilities flagged by scanning tools, whereas an “Architect” role might see overlays related to design compliance or performance thresholds. These overlays can be toggled on or off via feature flags, ensuring that end users and customers see only the standard UI, while authorized users (e.g., developers, security leads, CTOs) can view a detailed layer of engineering insights.

In an alternative embodiment suitable for smaller teams, a single user might hold multiple roles, such as security, performance, and cost optimization. The engine would aggregate findings across all those perspectives, consolidating them into a single overlay. This flexibility allows the disclosed method/approach to adapt to different organizational structures and development workflows.

For example, in day-to-day development tasks (where a developer needs immediate insight into how code changes affect security or performance) to high-level executive reviews (where a CTO can quickly assess whether the application meets the organization's defined best practices and “good behavior” standards) the disclosed system and approach/method can be used. By tapping into AI/ML capabilities, the system can also detect anomalies, provide remediation suggestions, and even generate plain-language summaries of complex issues.

The disclosed system's core functionality integrates multiple configuration perspectives, leveraging real-time data from various tools and knowledge bases, and presenting the resulting insights through an engine that overlays context-aware notifications and suggestions on the live application interface. This integrated approach improves SDLC comprehension, reduces communication gaps among stakeholders, and enables more efficient decision-making throughout the software lifecycle.

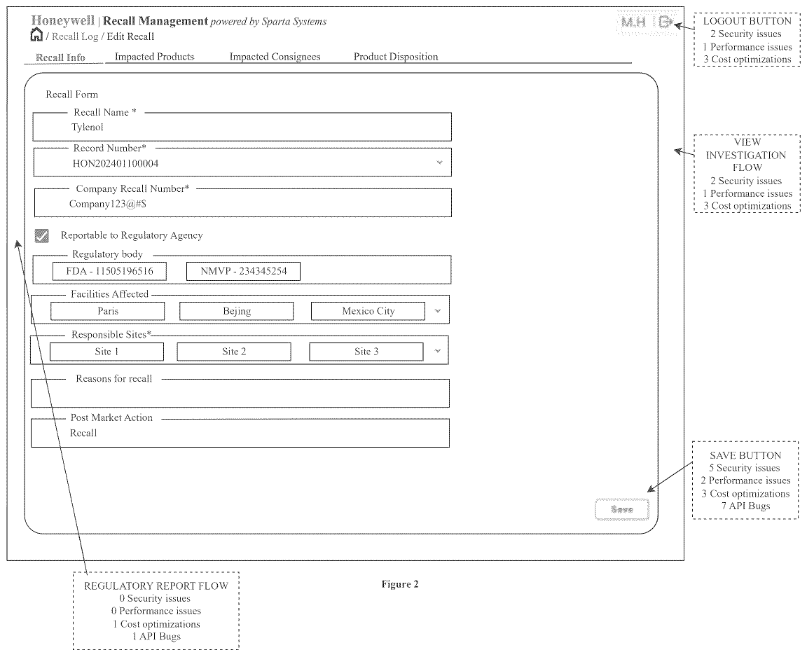

FIG. 2 depicts an illustrative user interface for a “Recall Management” application, demonstrating how the disclosed method overlays context-sensitive findings, such as security issues, cost optimizations, performance metrics, and API bugs-directly onto the screen according to an embodiment of this disclosure. In this example, the primary UI elements include a recall form with fields for “Recall Name,” “Recall Number,” “Company Recall Number,” and other details relevant to regulatory reporting. Along the right side of the figure, there are annotated flows (e.g., “Logout Button,” “View Investigation Flow,” and “Share Button”), each labeled with findings or alerts that may be pertinent to different user roles. Additionally, at the bottom of the screen, the “Regulatory Report Flow” highlights potential issues, such as security vulnerabilities or API bugs-that might arise when interacting with regulatory bodies.

In one embodiment, these overlays are activated through feature flags, providing a seamless mechanism to toggle between a standard user view and an insights-enhanced interface. When the flag is disabled, the screen appears as it would to an end user or customer, displaying only the conventional fields for data entry without any additional insights. However, when the flag is enabled for authorized users, such as architects, security champions, or financial stakeholders-the interface dynamically adapts to display real-time findings gathered from various Software Development Life Cycle (SDLC) checkpoints and external sources. These sources may include JIRA tickets for tracking development progress, security scans for identifying vulnerabilities, and cloud budgeting systems for monitoring cost efficiency.

For instance, an application interface may incorporate a “View Investigation Flow” link that, when activated, presents a badge summarizing critical insights such as “2 Security Issues,” “1 Performance Issue,” and “2 Cost Optimizations.” This structured summary enables users to quickly identify areas requiring attention. By clicking on or hovering over these badges, users can access more granular insights tailored to their role. For example, a security analyst may be presented with a breakdown of detected security threats, including severity levels and potential attack vectors. Similarly, a financial stakeholder might view suggested remediations for cost overruns, such as reducing redundant cloud resource usage or optimizing database configurations.

Additionally, developers and performance engineers may receive direct links to relevant JIRA tickets or code review suggestions that help expedite issue resolution. The system may further leverage AI-driven insights to provide contextual recommendations, ensuring that users not only see the issues but also receive guidance on the most effective remediation strategies. By integrating real-time data from multiple sources and providing role-specific overlays, the method ensures that different stakeholders can make informed decisions without switching between multiple tools or dashboards.

This functionality streamlines collaboration across multiple teams responsible for distinct KPIs-ranging from infrastructure design and application architecture to security adherence and cost management. A security champion might focus on the overlay segments related to vulnerability counts or compliance thresholds, while an architect might pay particular attention to performance bottlenecks or architectural misalignments flagged by the system. The figure exemplifies how each clickable UI component, such as a button or form field can be annotated with issues or recommendations pertinent to that specific element of the application.

In another embodiment, the overlay is further enriched by AI/ML or Generative AI capabilities. For example, if a detected vulnerability stems from broken authentication in an API, the system can query a Large Language Model (LLM) to provide a plain-language summary of the business impact highlighting the risk of unauthorized access or data leakage. This helps non-technical stakeholders, such as executives or regulatory compliance officers, quickly grasp the severity and implications of identified issues. Additionally, AI-driven anomaly detection can compare real-time data against a “good behavior” baseline defined, for instance, as fewer than two security violations per week or cloud costs under a certain threshold to flag deviations early and recommend immediate corrective actions.

For example, FIG. 2 is relevant during sign-off processes, such as when a CTO or product owner needs a holistic overview of the application's readiness for release. By scanning each screen in the UI, the executive can quickly determine whether outstanding issues remain, which teams are responsible for resolving them, and how each problem ties back to the underlying application components or services. This centralized, role-based view reduces the complexity of tracking disparate tickets or alerts across multiple tools, fostering a uniform understanding of the application's overall health.

FIG. 2 underscores the disclosure's core objective to unify the traditionally fragmented findings or insights from various phases of the SDLC into a single, visually intuitive layer. By doing so, it enables more efficient collaboration, better-informed decision-making, and a streamlined path toward meeting organizational goals for security, performance, cost optimization, and compliance—all of which are essential for delivering high-quality SaaS products.

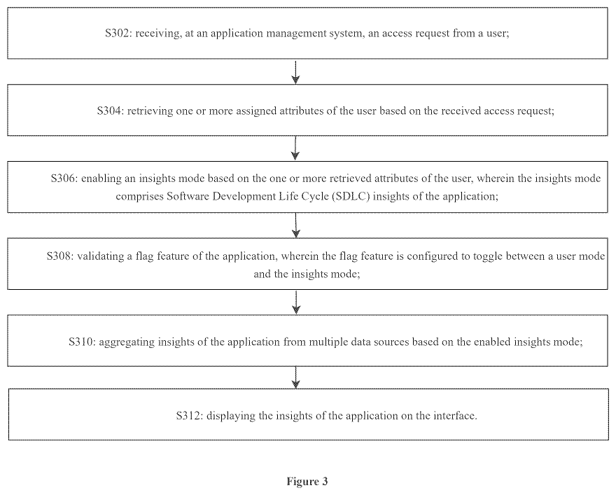

FIG. 3 illustrates a method for integrating insights into an application's interface, enabling real-time visibility into Software Development Life Cycle (SDLC) findings according to an embodiment of the disclosure. The method enhances decision-making by providing role-specific insights tailored to different stakeholders such as developers, security analysts, financial teams, and architects. The method begins with receiving an access request at an application management system, at step S302.

This step establishes a connection between the user and the insights system, ensuring that access is granted based on predefined rules and user roles. The access request may originate from various sources, including web-based or mobile applications where users log in through an interface, single sign-on (SSO) systems that utilize authentication mechanisms such as OAuth, SAML, or OpenID Connect, or API calls from external services that programmatically request insights.

Upon receiving the access request, the application management system performs multiple validation and authentication checks to ensure secure access, according to an embodiment. These checks include user authentication, where credentials such as usernames, passwords, or authentication tokens are verified. If the request originates from an SSO mechanism, cryptographic signatures or session details may be validated.

Additionally, the system verifies the user's role and permissions to determine their authorization level for accessing specific insights. For instance, a security analyst may have access to vulnerability insights, whereas a financial analyst may view cloud cost metrics. In high-security environments, multi-factor authentication (MFA) mechanisms, such as One-Time Passwords (OTP), biometric scans, or hardware-based authentication, may be required before granting access.

Further, the system may validate the device type, IP address, and geographic location from which the request originates to detect anomalies such as logins from unrecognized devices or restricted regions, triggering additional security measures if necessary. Once authentication is successful, a session is established, and an access token is issued to facilitate subsequent interactions with the application management system while maintaining session integrity.

Following authentication, the system retrieves the user's assigned attributes, such as their department, job function, or system-level privileges in the step S304. These attributes determine the scope of insights that the user can access, ensuring that the insights presented are relevant to their specific role. The completion of step S302 sets the foundation for enabling the insights mode, ensuring that only authorized users gain access to the relevant insights of the application.

In an embodiment, these attributes define the user's perspective on the application insights and may include security, financial operations, architecture, and performance-related parameters. For instance, security analysts may receive insights into API vulnerabilities and compliance issues, while finance teams focus on cloud expenditure trends and cost optimization. By leveraging these attributes, the system ensures that only relevant insights are displayed to each user.

Once the user's attributes are determined, the method comprises enabling an insights mode that overlays SDLC-related insights directly within the application interface at step S306. This allows different stakeholders to access data-driven insights seamlessly without requiring external dashboards. Developers may receive insights on code performance, security teams may monitor real-time risks, and finance teams can analyze cloud spending.

In an embodiment, once the system has authenticated the user and retrieved their attributes, the method comprises determining whether the user is authorized to access the insights mode. If authorized, the system dynamically activates this mode, ensuring that the user can seamlessly interact with relevant insights without navigating away from the application. This eliminates the need for external dashboards or standalone analytics tools, thereby streamlining workflows and improving efficiency.

In an embodiment, the insights mode functions as an overlay or an embedded visualization layer within the application interface, ensuring that insights are presented contextually based on the user's role. For example, a developer interacting with the application may receive insights on code performance metrics, such as execution time, memory consumption, or security vulnerabilities detected during static and dynamic analysis.

A security analyst may be presented with real-time alerts on API security risks, unauthorized access attempts, or compliance violations based on predefined security policies. Similarly, a financial team member may gain access to cloud spending patterns, budget utilization, or cost-saving recommendations, helping them make informed financial decisions. Additionally, architects can view insights on system scalability, infrastructure efficiency, and dependencies, ensuring optimal design choices.

To enhance usability, the method further comprises ensuring that the insights mode does not disrupt the user's primary workflow. In an embodiment, insights can be displayed through interactive widgets, collapsible side panels, pop-up overlays, or heatmaps that visually highlight critical areas requiring attention. Users may also have the ability to toggle the insights mode on or off through a designated flag feature, allowing them to switch between the standard user interface and the insights-enriched interface as needed.

Further, in an embodiment, the activation of the insights mode triggers backend processes that aggregate data from multiple sources, including security scans, cloud cost management systems, API testing reports, and historical logs. If artificial intelligence (AI)-based analysis is enabled, the system may generate real-time remediation suggestions based on historical trends and predefined thresholds. This ensures that stakeholders not only view insights but also receive actionable recommendations to improve application performance, security, and cost efficiency.

By enabling the insights mode at step S306, the method ensures that users across different domains can access role-specific, real-time insights directly within their workflow, fostering better decision-making and operational efficiency.

Further, to facilitate a seamless user experience, the method validates a flag feature that toggles between a standard user mode and the insights mode at step S308. This flag feature enables dynamic switching without requiring an application restart, ensuring that users can access insights in real-time without disrupting their workflow.

This validation ensures that users can access relevant insights in real-time while maintaining an uninterrupted workflow. The flag feature acts as a dynamic control mechanism, enabling stakeholders such as developers, security analysts, financial teams, and architects to switch between their regular application view and an enriched insights-driven interface based on their specific needs.

During validation, the system first checks whether the flag feature is enabled for the user based on their assigned attributes. If authorized, the feature becomes active, allowing the user to transition between the two modes effortlessly. This transition is designed to occur in real-time, eliminating the need for application reloading or manual configuration changes.

For instance, a developer reviewing application performance can quickly enable insights mode to view real-time execution metrics, security vulnerabilities, or API response times, and then revert to the standard mode to continue coding without distractions. Similarly, a security analyst may activate insights mode to monitor ongoing security threats and compliance alerts, and then toggle back to the standard mode once the analysis is complete.

The flag feature may be implemented through various mechanisms, such as a UI toggle button, keyboard shortcut, command-line interface (CLI) command, or API request. In some embodiments, the toggle is context-aware, meaning it adjusts the displayed insights dynamically based on the user's location within the application. For example, if a financial team member is analyzing cloud expenditures, toggling insights mode may display real-time budget tracking, cost optimization recommendations, and anomaly detection for unexpected spending spikes. On the other hand, if an architect is assessing application infrastructure, the mode may highlight system dependencies, scalability insights, and potential bottlenecks.

To ensure a seamless transition between modes, the system employs state management techniques that retain user settings and preferences when switching back and forth. This means that when a user exits the insights mode and later reactivates it, their previously accessed insights, filters, or visual settings remain intact, enhancing usability and efficiency. Additionally, the system may log mode-switching events for auditing and tracking purposes, providing organizations with visibility into how insights are being accessed and utilized.

By validating the flag feature, the method enhances the adaptability of the application, ensuring that users can efficiently access role-specific insights without disrupting their ongoing tasks. This capability fosters a more intuitive and productive experience, allowing stakeholders to make informed decisions while maintaining workflow continuity.

At step S310, after the insights mode is successfully enabled and the flag feature is validated, the system proceeds to aggregate relevant insights from multiple data sources, offering a comprehensive and contextual view of the application's state. This aggregation process consolidates critical information from various domains, including security, performance, financial operations, and system architecture, ensuring that stakeholders receive actionable insights tailored to their specific needs.

The system retrieves insights from security scans, which help detect potential vulnerabilities and misconfigurations that could pose risks to the application. Additionally, cloud cost management systems are integrated to provide real-time tracking of expenditures, budget optimization strategies, and anomaly detection for unexpected cost fluctuations. For development and integration assessments, the system incorporates API testing results, identifying potential failures, latency issues, or security gaps in API interactions. Moreover, the use of large language models (LLMs) enhances the insights by analyzing application documentation, security reports, and industry best practices to generate contextual recommendations. By combining real-time data with historical findings, the system ensures that users can reference prior remediation strategies, making it easier to understand patterns, track improvements, and anticipate future challenges.

To further enhance the decision-making process, the system leverages AI-based remediation suggestions. These suggestions are generated by analyzing historical data, predefined risk thresholds, and previously successful resolutions, enabling the system to recommend optimized solutions for recurring issues. For instance, if a security scan identifies a recurring vulnerability in an API, the system may suggest enforcing stricter authentication measures, such as multi-factor authentication (MFA) or token-based authorization, based on past remediations that effectively mitigated similar risks. Similarly, if performance metrics indicate high response times for certain API endpoints, the system may recommend caching mechanisms, database query optimizations, or load balancing strategies to enhance efficiency.

The aggregation process at step S310 is dynamic and continuously updated, ensuring that stakeholders always have access to the most relevant and up-to-date insights. To streamline data presentation, insights can be prioritized based on severity, relevance, or business impact, enabling users to focus on the most critical issues first. Further, in some embodiments, the system cross-references insights across different domains to uncover correlations—for example, linking a security vulnerability to an associated performance degradation or identifying financial inefficiencies linked to over-provisioned cloud resources.

By intelligently aggregating and correlating insights, step S310 enhances visibility across the Software Development Life Cycle (SDLC) and empowers stakeholders with data-driven decision-making capabilities. This ensures that developers, security analysts, architects, and financial teams can proactively identify, assess, and resolve issues in a timely and efficient manner, improving the overall stability, security, and cost-effectiveness of the application.

After aggregating insights, the method displays them on the application interface using several intuitive visualization mechanisms at step S312. Users can zoom in and zoom out to adjust the level of detail displayed, allowing them to either review high-level summaries or drill down into specific issues. Additionally, attribute-specific overlays ensure that different users receive insights relevant to their assigned roles. For example, an architect may view infrastructure-related insights while a security analyst sees threat assessments. The interface is also designed to be dynamically responsive, meaning the displayed insights update in real-time as the user navigates between different application screens, ensuring that only contextually relevant insights are presented at any given moment.

In some embodiments of step S312, the displayed insights are categorized based on severity levels, impact metrics, and historical trends, allowing users to prioritize their focus on the most critical findings. For instance, security vulnerabilities may be color-coded based on risk levels, with red indicating high-severity threats requiring immediate attention and yellow representing medium-risk concerns that should be addressed but are not immediately critical. Similarly, performance bottlenecks may be displayed with trend indicators, showing whether response times are improving or deteriorating over time. This structured presentation ensures that users can quickly assess the application's health and performance.

Additionally, the display interface supports interactive filtering mechanisms, enabling users to customize their insight's view based on specific parameters. For example, a developer may choose to display only code performance insights, while a financial analyst might filter for cloud expenditure data. In some embodiments, users can configure custom dashboards that persist their preferred insights layout, ensuring a personalized and efficient analysis experience. These dashboards can also be shared across teams, allowing collaborative decision-making based on the same set of curated insights.

Further, in some implementations, predictive analytics and AI-driven annotations are integrated into the displayed insights. For instance, if an insight suggests that a security vulnerability is similar to one that previously led to an incident in production, the system may highlight this correlation and recommend proactive mitigation steps. Similarly, if the system detects an upward trend in cloud costs, it may provide forecasted expenditure projections and suggest budget optimization measures, such as rightsizing resources or implementing auto-scaling policies.

In some embodiments, the displayed insights also include automated remediation options, where users can take direct action from the interface. For example, a security analyst detecting an exposed API key might be able to revoke the key or apply encryption policies directly through the insights panel. Likewise, an architect noticing inefficient infrastructure deployment may have the option to reallocate resources or optimize configurations without switching to an external platform. These actionable insights approach reduces the time needed to respond to issues and enhances workflow efficiency.

To further enhance usability, step S312 may incorporate voice-based commands or chatbot-driven recommendations, allowing users to query insights using natural language. For instance, a developer could ask, “What are the top security risks in the last deployment?”, and the system would generate a detailed response highlighting the most pressing concerns. This natural language processing (NLP)-based interaction ensures that insights are accessible even to non-technical stakeholders, fostering cross-functional collaboration.

By implementing dynamic, interactive, and AI-powered visualization mechanisms, step S312 ensures that insights are not only displayed but also contextually enriched and actionable, empowering users to make informed decisions that drive continuous improvement in the Software Development Life Cycle (SDLC).

To enhance accuracy and relevance, the application management system is integrated with external platforms such as JIRA, Confluence, security scanners, and cloud budget explorers. These integrations allow the system to fetch up-to-date development tickets, unresolved issues, security vulnerabilities, and cost data, ensuring that insights remain current and actionable. Further, in some embodiments, the system generates business impact analysis using LLM-based evaluation of API signatures and security risks. This analysis translates technical findings into business-relevant insights. For example, if an API exhibits a broken authentication mechanism, the system might generate a high-level business impact summary stating: “Unauthorized Access: Attackers may exploit the broken authentication in the APQR service, exposing sensitive company reports to unauthorized users.” Such insights help executives and decision-makers assess risks beyond technical specifications.

The method provides an intelligent and dynamic mechanism for integrating SDLC insights directly into an application's interface. By tailoring insights based on user roles, aggregating data from multiple sources, and leveraging AI-driven remediation suggestions, the system enhances transparency, streamlines issue resolution, and enables proactive risk mitigation. The ability to toggle between user mode and insights mode, zoom into specific findings, and dynamically update displayed insights ensures a comprehensive and intuitive user experience. This approach empowers organizations to maintain high software quality, optimize costs, and address security and performance challenges efficiently within the software development lifecycle.

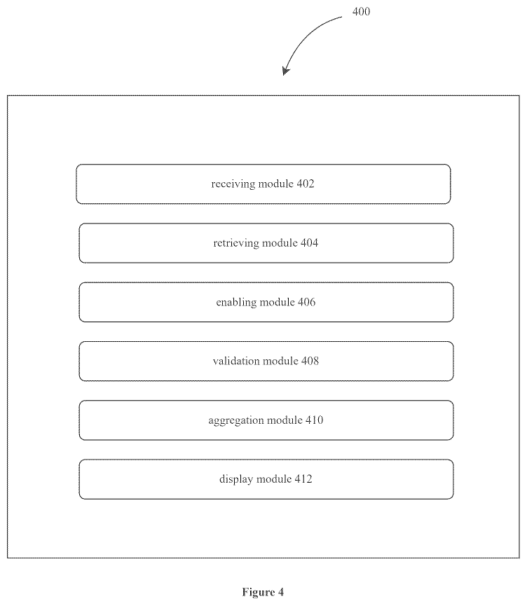

FIG. 4 illustrates an application management system 400 that enables the seamless integration of insights into an application interface according to an embodiment of this disclosure. This system 400 provides real-time, role-based insights tailored to various stakeholders, such as developers, security analysts, architects, and financial teams. By dynamically retrieving, analyzing, and displaying insights, the system 400 enhances the decision-making process and ensures that actionable information is readily available within the application's workflow. The system 400 comprises a receiving module 402, a retrieving module 404, an enabling module 406, a validation module 408, an aggregation module 410, and a display module 412.

The receiving module 402 is a core component of the application management system responsible for handling access requests from users. When a user attempts to access the system, this module captures and processes the request, ensuring that it is authenticated and meets the necessary access control criteria. The request may originate from various user interfaces, including web-based dashboards, integrated development environments (IDEs), or mobile applications. In an embodiment, the receiving module 402 verifies the identity of the user, either through login credentials, Single Sign-On (SSO) authentication, or token-based authorization, before forwarding the request for further processing.

Once the request is received and authenticated, the retrieving module 404 is triggered to determine the user's assigned attributes. These attributes define the level and type of insights the user is permitted to access within the system. For example, a security analyst might be granted visibility into vulnerability scans, threat intelligence reports, and compliance audit findings, whereas a financial operations manager might only access cloud expenditure summaries, budget alerts, and cost optimization insights. Similarly, software architects may be provided with insights into infrastructure configurations, application dependencies, and architectural bottlenecks, while performance engineers could receive reports related to system latency, API response times, and load testing results.

In some embodiments, these assigned attributes are dynamically retrieved based on predefined access policies or role-based access control (RBAC) frameworks. This ensures that each stakeholder receives customized insights relevant to their responsibilities, enhancing decision-making and reducing information overload. Further, the retrieving module 404 may integrate with enterprise directory services (e.g., Active Directory, LDAP) or identity and access management (IAM) platforms to pull user role definitions and associated permissions.

Additionally, in scenarios where a user has multiple overlapping roles (e.g., a DevOps engineer responsible for both security and performance optimization), the system may apply context-aware filtering to tailor insights accordingly. This ensures that users see only the most relevant information without redundant or extraneous data cluttering their interface. By leveraging these mechanisms, the receiving module 402 and retrieving module 404 work in tandem to facilitate secure, role-specific access to insights, enhancing operational efficiency across diverse user groups.

Once the user's attributes are determined, the enabling module 406 is triggered to activate an insights mode, which overlays Software Development Life Cycle (SDLC) insights directly onto the application interface. This mode dynamically enhances the user experience by embedding real-time, context-aware insights within the same environment where users perform their tasks. By eliminating the need for external dashboards or third-party monitoring tools, the insights mode streamlines workflow efficiency and ensures that decision-making is driven by up-to-date, actionable intelligence.

The insights mode is designed to be highly customizable, adapting to the unique needs of different stakeholders based on their assigned attributes. For developers, the mode provides performance-related insights, such as execution time bottlenecks, inefficient code paths, memory leaks, and potential concurrency issues. Developers can view these insights in real time, allowing them to optimize code performance while writing or reviewing it. Additionally, automated recommendations based on historical performance data and best practices may be provided to assist in debugging and optimization.

For security analysts, the insights mode enables continuous monitoring of real-time threats and vulnerabilities. Integrated with security scanners, penetration testing reports, and compliance tools, the system proactively flags security issues, such as unpatched dependencies, misconfigured access controls, or API security risks. Analysts can view risk severity levels, remediation suggestions, and direct links to corresponding security policies. Additionally, the mode may provide automated threat mitigation recommendations, leveraging AI-based analysis of past security incidents and threat intelligence feeds.

For architects, the insights mode offers a comprehensive overview of infrastructure efficiency, highlighting potential architectural flaws, resource misallocations, and system scalability concerns. The module aggregates insights from infrastructure monitoring tools, configuration management systems, and historical performance data to present recommendations on architectural improvements. For example, if a particular microservice experiences frequent failure under load, the system might suggest container reallocation, database indexing optimizations, or API gateway enhancements.

For financial teams, the insights mode tracks cloud spending trends, offering real-time visibility into cost allocation, budget utilization, and potential areas for optimization. By integrating with cloud cost management platforms, the system identifies overprovisioned resources, underutilized compute instances, and potential cost-saving opportunities. Finance teams can receive proactive alerts when spending thresholds are exceeded and explore historical spending patterns to forecast future budgets accurately.

In some embodiments, the insights mode also allows cross-functional collaboration, enabling different teams to share their findings through interactive annotations, tagged comments, and automated report generation. This facilitates a unified decision-making process, where developers, security analysts, architects, and finance teams can collectively assess issues, propose solutions, and track their implementation progress all within the same interface.

By activating the insights mode through the enabling module 406, the system ensures that role-specific, real-time insights are seamlessly embedded into the application workflow, empowering users to make data-driven decisions without context switching or workflow disruption.

To ensure seamless user interaction, the validation module 408 performs a critical role in validating a flag feature that allows users to toggle between a standard user mode and an insights mode. This dynamic toggling capability ensures that users can access real-time insights when needed while preserving the standard application interface when insights are not required. The validation module 408 verifies the correct operation of the flag feature, ensuring that transitions between these modes occur smoothly, securely, and without unintended disruptions to the user experience.

In some embodiments, the flag feature is designed to enable real-time switching between the user mode and the insights mode without requiring an application restart. This eliminates the need for users to refresh or reload the application, reducing downtime and workflow disruptions. For instance, a developer debugging an issue may activate the insights mode to view performance bottlenecks or security vulnerabilities and, after adjusting, seamlessly revert to the standard user mode to test the application under normal conditions. Similarly, a security analyst reviewing a live application deployment can enable insights mode to monitor security threats in real time and disable it when no further monitoring is required.

To maintain system stability and efficiency, the validation module ensures that switching between modes does not interfere with ongoing processes, affect user permissions, or overload system resources. In some implementations, the module dynamically loads and unloads insights-related overlays and data sources to optimize performance. For example, when a financial stakeholder toggles into insights mode to assess cloud spending trends, the system loads cost analytics without affecting application functionality for other users operating in standard mode.

Additionally, the validation module enforces user access controls, ensuring that only authorized users can activate the insights mode. For example, a regular end user accessing the application may not have permission to enable the insights mode, whereas an architect, developer, or security professional with the appropriate credentials can toggle between modes at will. The module cross-references user attributes retrieved from the retrieving module 404 to determine whether the user has the necessary permissions before allowing the switch.

In some embodiments, the flag feature may be extended to support partial activation, where users can selectively enable specific types of insights. For instance, a developer may choose to activate only performance-related insights, while a security analyst may opt to enable only security-related findings. This granular control enhances usability, ensuring that users are not overwhelmed with excessive data while still accessing the insights most relevant to their responsibilities.

By integrating real-time validation, dynamic permission checks, and efficient resource management, the validation module 408 ensures that users can seamlessly transition between standard and insights modes without any disruptions, empowering them to make informed decisions without interrupting their workflow.

The aggregation module 410 is configured to collect and consolidate insights from multiple data sources. These sources include security scans for vulnerability detection, cloud cost management systems for financial tracking, Application Programming Interface (API) testing results for integration analysis, large language models (LLMs) for contextual intelligence, and historical insights for trend analysis. By aggregating data from diverse sources, the system 400 provides a comprehensive view of the application's health, security, and performance metrics.

In some embodiments, the aggregation module 410 also leverages AI-based remediation suggestions. This involves analyzing historical data, predefined risk thresholds, and past remediation strategies to recommend optimal solutions. For example, if a recurring security vulnerability is detected, the system 400 may suggest implementing stricter authentication controls based on previous successful mitigations. Similarly, if cloud expenditures exceed budget thresholds, the system 400 may propose resource optimizations or auto-scaling configurations.

Once insights are aggregated, the display module 412 dynamically presents them on the application interface. The module provides zoom-in and zoom-out functionalities, allowing users to adjust the level of detail displayed. This enables users to either view high-level summaries or drill down into granular insights. Additionally, the display module supports attribute-specific overlays, tailoring the insights based on the user's role and responsibilities. For instance, a security analyst may receive a vulnerability risk map, while an architect may see an infrastructure dependency chart.

To further enhance usability, the display module 412 supports real-time updates, ensuring that insights dynamically adjust as users navigate different application screens. This prevents information overload and ensures that only contextually relevant insights are displayed at any given moment. Additionally, in some embodiments, the system 400 integrates business impact assessments by performing LLM-based analysis on API signatures and corresponding security risks. This helps stakeholders understand the potential impact of vulnerabilities or performance issues in business terms, facilitating informed decision-making.

In some embodiments, the system 400 also includes an integration module configured to connect with external platforms such as JIRA, Confluence, security scanners, and cloud budget explorers. This integration enables seamless retrieval of insights from various tools, ensuring that the application management system 400 remains up to date with the latest development, security, and operational data.

By incorporating these modules and capabilities, the application management system 400 ensures that insights are not only accessible but also actionable, intuitive, and seamlessly integrated into the user's workflow. This results in improved efficiency, faster issue resolution, and more informed decision-making across different application lifecycle stages.

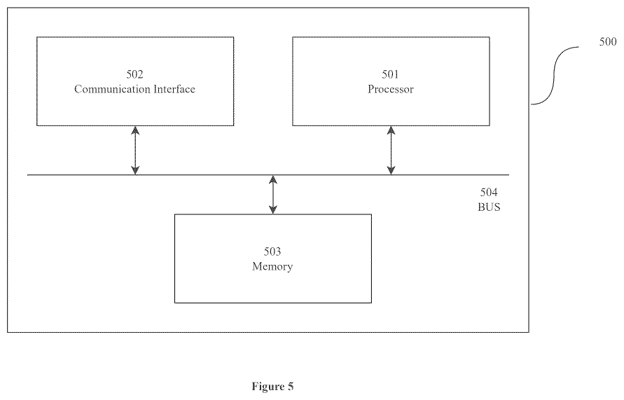

FIG. 5 illustrates a schematic diagram of another communication apparatus 500 according to an embodiment of the disclosure. The communication apparatus 500 includes a processor 501, a communication interface 502, and a memory 503. The processor 501, the communication interface 502, and the memory 503 may be connected to each other via a bus 504. The bus 504 may be a peripheral component interconnect (peripheral component interconnect, PCI) bus, an extended industry standard architecture (extended industry standard architecture, EISA) bus, or the like. The bus 504 may be classified into an address bus, a data bus, a control bus, and the like. For ease of representation, the bus is represented by using only one line in FIG. 5, but it does not indicate that there is only one bus or one type of bus.

The processor 501 may be a central processing unit (central processing unit, CPU), a network processor (network processor, NP), or a combination of a CPU and an NP. The processor may further include a hardware chip. The hardware chip may be an application-specific integrated circuit (application-specific integrated circuit, ASIC), a programmable logic device (programmable logic device, PLD), or a combination thereof. The PLD may be a complex programmable logic device (complex programmable logic device, CPLD), a field-programmable gate array (field-programmable gate array, FPGA), generic array logic (Generic Array Logic, GAL), or any combination thereof. The memory 503 may be a volatile memory or a non-volatile memory or may include a volatile memory and a non-volatile memory. The non-volatile memory may be a read-only memory (read-only memory, ROM), a programmable read-only memory (programmable ROM, PROM), an erasable programmable read-only memory (erasable PROM, EPROM), an electrically erasable programmable read-only memory (electrically EPROM, EEPROM), or a flash memory. The volatile memory may be a random-access memory (random access memory, RAM), and is used as an external cache.

The connecting lines shown in the various figures contained herein are intended to represent exemplary functional relationships and/or physical couplings between the various elements. It should be noted that many alternative or additional functional relationships or physical connections may be present in an embodiment of the subject matter.

The subject matter may be described herein in terms of functional and/or logical block components, and with reference to symbolic representations of operations, processing tasks, and functions that may be performed by various computing components or products. It should be appreciated that the various block components shown in the figures may be realized by any number of hardware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control products. Furthermore, embodiments of the subject matter described herein can be stored on, encoded on, or otherwise embodied by any suitable non-transitory computer-readable medium as computer-executable instructions or data stored thereon that, when executed (e.g., by a processing system), facilitate the processes described above.

Usually, various embodiments of this disclosure may be implemented by hardware or a dedicated circuit, software, logic, or any combination thereof. Some aspects may be implemented by the hardware, and other aspects may be implemented by firmware or software, and may be performed by a controller, a microprocessor, or another computing device. Although aspects of embodiments of this disclosure are shown and described as block diagrams, flowcharts, or some other figures, it should be understood that the blocks, apparatuses, systems, technologies, or methods described in this specification may be implemented as, for example, non-limiting examples, hardware, software, firmware, dedicated circuits or logic, general-purpose hardware or controllers or other computing devices, or a combination thereof.

This disclosure further provides at least one computer program product tangibly stored on a non-transitory computer-readable storage medium. The computer program product includes computer-executable instructions, such as instructions included in a program module, which are executed in a device on a real or virtual processor of a target, to perform the processes/methods described above with reference to the accompanying drawings. Usually, a program module includes a routine, a program, a library, an object, a class, a component, a data structure, or the like that performs a particular task or implements a particular abstract data type. In various embodiments, functions of the program module may be combined, or a function of the program module may be as needed. Machine-executable instructions for the program module may be executed locally or within a distributed device. In the distributed device, the program module may be located in local and remote storage media.

Computer program code for implementing the method disclosed in this disclosure may be written in one or more programming languages. The computer program code may be provided for a processor of a general-purpose computer, a dedicated computer, or another programmable data processing apparatus, so that when the program code is executed by the computer or another programmable data processing apparatus, a function/operation specified in the flowchart and/or the block diagram is implemented. The program code may be completely executed on a computer, partially executed on a computer, independently performed as a software package, partially executed on a computer and partially executed on a remote computer, or completely executed on a remote computer or a server.

In context of this disclosure, the computer program code or related data may be borne in any appropriate carrier, so that the device, the apparatus, or the processor can perform various processing and operations described above. An example of the carrier includes a signal, a computer-readable medium, and the like. An example of the signal may include propagating signals in electrical, optical, radio, sound, or other forms, such as carrier waves and infrared signals.

The computer-readable medium may be any tangible medium that includes or stores a program used for or related to an instruction execution system, apparatus, or device. The computer-readable medium may be a computer-readable signal medium or a computer-readable storage medium. The computer-readable medium may include but is not limited to an electronic, magnetic, optical, electromagnetic, infrared, or semiconductor system, apparatus, or device, or any suitable combination thereof. A more detailed example of the computer-readable storage medium includes an electrical connection with one or more wires, a portable computer disk, a hard disk, a random-access memory (RAM), a read-only memory (ROM), an erasable programmable read-only memory (EPROM or flash memory), an optical storage device, a magnetic storage device, or any suitable combination thereof.

The foregoing description refers to elements or nodes or features being “coupled” together. As used herein, unless expressly stated otherwise, “coupled” means that one element/node/feature is directly or indirectly joined to (or directly or indirectly communicates with) another element/node/feature, and not necessarily mechanically. Thus, although the drawings may depict one exemplary arrangement of elements directly connected to one another, additional intervening elements, products, features, or components may be present in an embodiment of the depicted subject matter. In addition, certain terminology may also be used herein for the purpose of reference only, and thus are not intended to be limiting.

The foregoing detailed description is merely exemplary in nature and is not intended to limit the subject matter of the application and uses thereof. Furthermore, there is no intention to be bound by any theory presented in the preceding background, brief summary, or the detailed description.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the subject matter in any way. Rather, the foregoing detailed description will provide those skilled in the art with a convenient road map for implementing an exemplary embodiment of the subject matter. It should be understood that various changes may be made in the function and arrangement of elements described in an exemplary embodiment without departing from the scope of the subject matter as set forth in the appended claims. Accordingly, details of the exemplary embodiments or other limitations described above should not be read into the claims absent a clear intention to the contrary.

What is claimed is:

1. A method of integrating insights into an interface of an application, comprising:
receiving, at an application management system, an access request from a user;
retrieving one or more assigned attributes of the user based on the received access request;
enabling an insights mode based on the one or more retrieved attributes of the user, wherein the insights mode comprises Software Development Life Cycle (SDLC) insights of the application;
validating a flag feature of the application, wherein the flag feature is configured to toggle between a user mode and the insights mode;
aggregating insights of the application from multiple data sources based on the enabled insights mode; and
displaying the insights of the application on the interface.

2. The method of claim 1, wherein displaying the insights of the application on the interface comprises enabling zoom-in and zoom-out functionalities for adjusting a level of detail of the displayed insights of the application.

3. The method of claim 1, wherein aggregating the insights of the application from the multiple data sources comprises generating AI-based remediation suggestions, wherein generating the AI-based remediation suggestions comprising:
analysing historical data and prior remediation strategies associated with the insights of the application, and
generating the AI-based remediation suggestions for the insights based on one or more predefined thresholds, the historical data, and the prior remediation strategies.

4. The method of claim 1, wherein the one or more assigned attributes comprise one or more of security, financial operations, architecture, and performance perspectives.

5. The method of claim 1, wherein the multiple data sources further comprise one or more of:
security scans;
cloud cost management systems;
Application Programming Interface (API) testing results;
large language models (LLMs); and
historical insights.

6. The method of claim 1, further comprising integrating the application management system with one or more external systems including:
JIRA;
Confluence;
security scanners; and
cloud budget explorers, to retrieve the insights.

7. The method of claim 1, wherein displaying the insights of the application on the interface further comprises providing attribute-specific overlays to tailor the displayed insights of the application based on the respective assigned attributes of different users.

8. The method of claim 1, wherein the flag feature is toggled in real time between the user mode and the insights mode without requiring a restart of the application.

9. The method of claim 1, further comprising generating business impact information for the aggregated insights of the application by performing an LLM-based analysis of API signatures and corresponding security risks.

10. The method of claim 1, further comprising dynamically updating the display of insights on the interface as the user navigates between different screens of the application.

11. An application management system of integrating insights into an interface of an application, the system comprising:
a receiving module configured to receive an access request from a user;
a retrieving module configured to retrieve one or more assigned attributes of the user based on the received access request;
an enabling module configured to activate an insights mode based on the one or more retrieved attributes of the user, wherein the insights mode comprises Software Development Life Cycle (SDLC) insights of the application;
a validation module configured to validate a flag feature of the application, wherein the flag feature is configured to toggle between a user mode and the insights mode;
an aggregation module configured to retrieve and collect insights of the application from multiple data sources based on the enabled insights mode; and
a display module configured to dynamically display the insights of the application on the interface.

12. The system of claim 11, wherein the display module is further configured to enable zoom-in and zoom-out functionalities for adjusting a level of detail of the displayed insights of the application.

13. The system of claim 11, wherein the aggregation module is further configured to generate AI-based remediation suggestions, wherein generating the AI-based remediation suggestions comprising:
analysing historical data and prior remediation strategies associated with the insights of the application, and
generating the AI-based remediation suggestions for the insights based on one or more predefined thresholds, the historical data, and the prior remediation strategies.

14. The system of claim 11, wherein the one or more assigned attributes comprise one or more of security, financial operations, architecture, and performance perspectives.

15. The system of claim 11, wherein the multiple data sources further comprise one or more of:
security scans;
cloud cost management systems;
Application Programming Interface (API) testing results;
large language models (LLMs); and
historical insights.

16. The system of claim 11, further comprising an integration module configured to integrate with one or more external systems including:
JIRA;
Confluence;
security scanners; and
cloud budget explorers, to retrieve the insights.

17. The system of claim 11, wherein the display module is further configured to provide attribute-specific overlays to tailor the displayed insights of the application based on the respective assigned attributes of different users.

18. The system of claim 11, wherein the flag feature is toggled in real time between the user mode and the insights mode without requiring a restart of the application.

19. The system of claim 11, further comprising a generation module configured to generate business impact information for the aggregated insights of the application by performing an LLM-based analysis of API signatures and corresponding security risks.

20. A non-transitory computer-readable medium having stored thereon computer-executable instructions that, when executed by a processor, cause the processor to execute a method of integrating insights into an interface of an application, comprising:
receiving, at an application management system, an access request from a user;
retrieving one or more assigned attributes of the user based on the received access request;
enabling an insights mode based on the one or more retrieved attributes of the user, wherein the insights mode comprises Software Development Life Cycle (SDLC) insights of the application;
validating a flag feature of the application, wherein the flag feature is configured to toggle between a user mode and the insights mode;
aggregating insights of the application from multiple data sources based on the enabled insights mode; and
displaying the insights of the application on the interface.
